(19) United States
(12) Patent Application Publication
(10) Pub. No.: US 2013/0030678 A1
(43) Pub. Date: Jan. 31, 2013

(54) CONTROL DEVICE FOR INTERNAL COMBUSTION ENGINE

(71) Applicants: Keiichiro Aoki, Sunto-gun (JP); Hiroki Nishijima, Sunto-gun (JP)

(72) Inventors: Keiichiro Aoki, Sunto-gun (JP); Hiroki Nishijima, Sunto-gun (JP)

(73) Assignee: TOYOTA JIDOSHA KABUSHIKI KAISHA, Aichi-ken (JP)

(21) Appl. No.: 13/511,745

(22) PCT Filed: Jul. 25, 2011
(86) PCT No.: PCT/JP2011/066859

§ 371 Date: May 24, 2012

(51) Int. Cl. F01N 11/00; F02D 28/00

(52) U.S. Cl. 701/113

(57) ABSTRACT

A particulate matter sensor (8) is installed in an exhaust path (4) of an internal combustion engine (2) to generate an output in accordance with the amount of particulate matter in a gas. Disclosed is a control device (10) that includes means for detecting the output of the particulate matter sensor (8), means for detecting information about the operating status of the internal combustion engine (2), and means for correcting the output in accordance with the information during a predetermined period from the startup to warm-up of the internal combustion engine. Correcting the output at the start of the internal combustion engine as described above suppresses the output variations of the particulate matter sensor (8), which occur due to the differences in particulate matter diameter and sensor temperature.

### TECHNICAL FIELD

The present invention relates to a control device for an internal combustion engine. More specifically, the present invention relates to a control device for an internal combustion engine having a particulate matter sensor that is installed in an exhaust path of the internal combustion engine to detect the amount of particulate matter in exhaust gas.

### Background Art

A sensor for detecting the amount of particulate matter (hereinafter, referred to as PM) in the exhaust gas of an internal combustion engine is disclosed, for instance, in Patent Document 1. The sensor disclosed in Patent Document 1 includes an insulation layer, which attracts the PM, and a pair of electrodes, which are disposed on the insulation layer and positioned apart from each other. If the sensor comes into contact with the exhaust gas to let the PM in the exhaust gas deposit between the electrodes, the conductivity between the electrodes changes with the amount of deposited PM, thereby changing the resistance between the electrodes. Therefore, by detecting the resistance between the sensor electrodes, the amount of PM deposited between the electrodes is detected. In accordance with the amount of deposited PM, the amount of PM in the exhaust gas is estimated to judge, for instance, whether a PM collection filter is faulty.

### PRIOR ART LITERATURE

### Patent Document

Patent Document 1: JP-2008-190502-A

### SUMMARY OF THE INVENTION

### Problem to be Solved by the Invention

When an internal combustion engine starts, its exhaust gas tends to contain PM having a large particle diameter. When PM having a large particle diameter is deposited between the sensor electrodes, even a small amount of PM increases the conductivity between the electrodes so that the sensor readily outputs a value greater than a value equivalent to an actual amount of PM. Further, the temperature of an element portion of the sensor affects the resistance between the electrodes. Thus, it is conceivable that the sensor output may vary when internal combustion engine starts.

Therefore, a sensor output detection sequence generally starts after the sensor is warmed up at the start of the internal combustion engine. Hence, it is conceivable that the sensor may be warmed up with a delay after internal combustion engine startup. However, it is preferred that control based on a PM sensor output, such as PM amount detection and filter fault judgment, be exercisable without an undue delay after internal combustion engine startup.

The present invention aims to solve the above-described problem by providing improved control device for the combustion engine, in which the control device is improved on its readiness for the measurement of the PM amount upon starting of the combustion engine.

### Means for Solving the Problem

To achieve the above-mentioned object, the present invention provides a control device for a combustion engine including a particulate matter sensor that is installed in an exhaust path of the internal combustion engine for generating an output in accordance with the amount of particulate matter in a gas. The control device includes means for detecting the output of the particulate matter sensor, means for detecting information about the operating status of the internal combustion engine, and means for correcting the output in accordance with the information during a predetermined period from the startup to the warm-up of the internal combustion engine.

In the present invention, the control device may further include means for eliminating the particulate matter deposited on an element portion of the particulate matter sensor by heating the element portion to a reference temperature after internal combustion engine warm-up.

In the present invention, the means for detecting the information about the operating status may continue to detect the information about the operating status during a period from the start of the internal combustion engine to the instant at which the particulate matter sensor is warmed up, and the means for correcting the output may continue to correct the output during a period from the start of the internal combustion engine to the instant at which the particulate matter sensor is warmed up.

In the present invention, the means for detecting the information about the operating status, when the internal combustion engine cold starts, may continue to detect the information about the operating status during a period from the cold start of the internal combustion engine to the instant at which the internal combustion engine is warmed up, and the means for correcting the output may continue to correct the output during a period from the cold start of the internal combustion engine to the instant at which the internal combustion engine is warmed up.

In the present invention, at least one of the temperature of cooling water for the internal combustion engine, a cumulative intake air amount reached since the start of the internal combustion engine, and a cumulative fuel injection amount reached since the start of the internal combustion engine may be detected as the information about the operating status.

In the present invention, the control device may further include means for judging, in accordance with the output corrected by the means for correcting the output, whether a filter for collecting the particulate matter is faulty, means for eliminating the particulate matter deposited on the element portion of the particulate matter sensor by heating the element portion to the reference temperature after judging whether the filter is faulty, and means for maintaining the element portion of the particulate matter sensor at a temperature higher than the reference temperature during a period from the instant at which the particulate matter is eliminated to the instant at which the internal combustion engine is stopped.

### Effects of the Invention

According to the present invention, the output of the particulate matter sensor can be corrected in accordance with the information about the operating status of the internal combustion engine during a predetermined period from the start of the internal combustion engine to the instant at which the internal combustion engine is warmed up. During a period from the startup to the warm-up of the internal combustion engine, for example, the size of the particulate matter in exhaust gas and the temperature of the exhaust gas may significantly change to vary the output of the particulate matter sensor. Hence, the present invention can reduce variations in the output of the particulate matter sensor, which are attributed to the operating status of the internal combustion engine, by making the output of the particulate matter sensor correctable in accordance with the operating status of the internal combustion engine during the period from the startup to the warm-up of internal combustion engine.

A process for heating the element portion of the particulate matter sensor to eliminate the particulate matter deposited on the element portion is generally performed after the internal combustion engine is warmed up. Therefore, the particulate matter sensor is not usually used during a period from the instant at which the internal combustion engine is warmed up to the instant at which the particulate matter is eliminated from the element portion of the particulate matter sensor. In this respect, the present invention uses a corrected output of the particulate matter sensor during a period from the startup to the warm-up of internal combustion engine and eliminates the particulate matter deposited on the element portion after internal combustion engine warm-up. Therefore, the present invention makes the particulate matter sensor usable immediately after internal combustion engine startup as well as reduces the period during which the particulate matter sensor is not available, but also to use.

Further, the sensor output is likely to vary depending on the magnitude of particulate matter diameter and changes in the resistance of the particulate matter sensor during a period from the startup of the internal combustion engine to the warm-up of particulate matter sensor and during a period from the cold startup to warm-up of the internal combustion engine. In this respect, as far as the sensor output is continuously corrected in accordance with the information about the operating status during a period from the startup of the internal combustion engine to the warm-up of the particulate matter sensor and during a period from the cold startup to the warm-up of the internal combustion engine, sensor output variations can be properly corrected while they are particularly likely to occur.

Furthermore, in particular, the exhaust gas temperature, cumulative intake air amount, and cumulative fuel injection amount are parameters related to the sensor output as they are likely to affect the diameter of the particulate matter in the exhaust gas and the element temperature of the particulate matter sensor. Therefore, as far as the output of the particulate matter sensor is corrected in accordance with these parameters, the output variations of the particulate matter sensor, which occur at the start of the internal combustion engine, can be corrected with increased appropriateness.

Moreover, when the element portion of the particulate matter sensor is maintained at a high temperature during a period from after the particulate matter is eliminated from the element portion of the sensor to the instant at which the internal combustion engine is stopped, it is possible to ensure that no particulate matter is deposited on the element portion of the particulate matter sensor at the next start of the internal combustion engine. Consequently, after the next start of the internal combustion engine, it is possible to start using the particulate matter sensor without having to eliminate particulate matter from the element portion. Even if the temperature is low in this instance, the present invention corrects the output of the particulate matter sensor in accordance with the operating status. Therefore, the output of the particulate matter sensor can be effectively used while suppressing the influence of the operating status at the start of the internal combustion engine.

### BRIEF DESCRIPTION OF DRAWINGS

FIG. 1 is a diagram illustrating the overall configuration of a system according to the present embodiment of the present invention.

FIG. 2 is a diagram illustrating an element portion of the PM sensor according to the present embodiment of the present invention.

FIG. 3 is a diagram illustrating the relationship between the water temperature and the output sensitivity and output correction value of the PM sensor according to the present embodiment of the present invention.

FIG. 4 is a flowchart illustrating another control routine that is executed by the control device according to the present embodiment of the present invention.

### MODES FOR CARRYING OUT THE INVENTION

An embodiment of the present invention will now be described with reference to the accompanying drawings. Elements that are shown in the drawings and identical or equivalent to each other are designated by the same reference numerals and will not be redundantly described.

### Embodiment

### [System Configuration According to Present Embodiment]

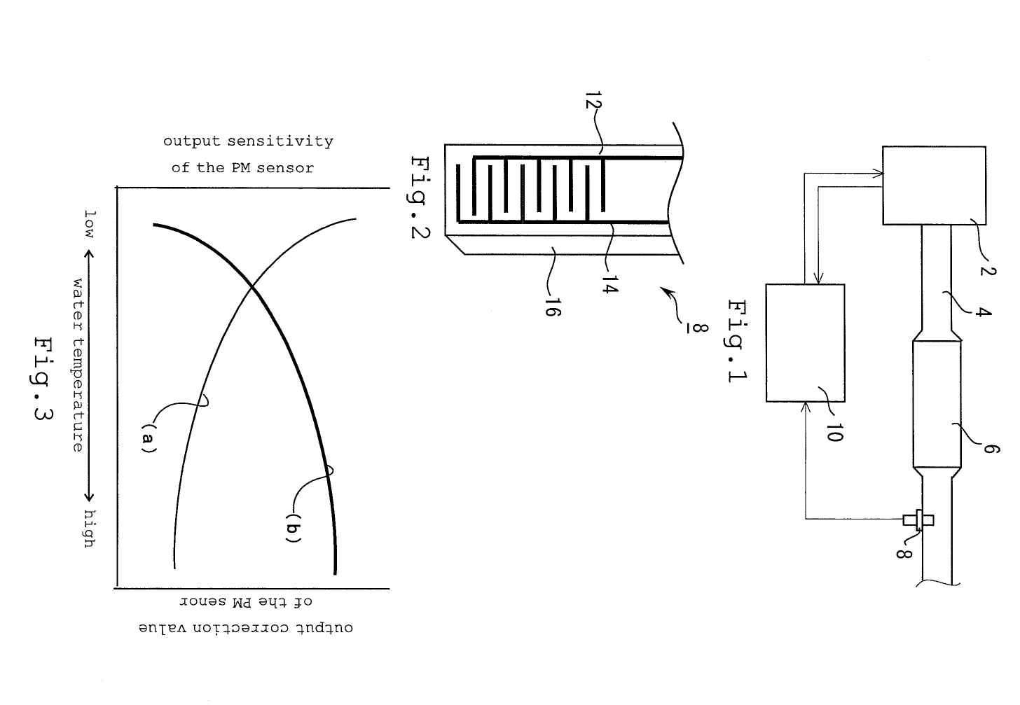

FIG. 1 is a diagram illustrating the overall configuration of a system according to the present embodiment of the present invention. In the system shown in FIG. 1, a DPF (diesel particulate filter) 6 is installed in an exhaust path 4 of an internal combustion engine 2. The DPF 6 is a filter that collects particulate matter (PM) contained in exhaust gas. A PM sensor 8 (particulate matter sensor) is installed in the exhaust path 4 and positioned downstream of the DPF 6. In the system, the PM sensor 8 is used to detect the amount of PM contained in the exhaust gas that passes through the DPF 6.

The system includes a control device 10. The input side of the control device 10 is connected to the PM sensor and various other sensors. The output side of the control device 10 is connected to various actuators of the internal combustion engine 2. In accordance with input information supplied from the various sensors, the control device 10 executes a predetermined program to operate the various actuators in such a manner as to operate the internal combustion engine 2 with various controls.

FIG. 2 is an enlarged schematic diagram illustrating an element portion of the PM sensor 8 according to the present embodiment. As shown in FIG. 2, the element portion of the PM sensor 8 includes a pair of electrodes 12, 14, which are mounted on a surface of the element portion. The pair of electrodes 12, 14 are not in contact with each other as they are disposed at a fixed distance from each other. Further, the electrodes 12, 14 each include a comb-tines-shaped portion. The comb-tines-shaped portions of the electrodes 12, 14 are disposed so that they mesh with each other. The electrodes 12, 14 are in contact with an insulation layer 16, which is formed beneath the electrodes 12, 14. A heater (not shown) is embedded in an underlayer for the electrodes 12, 14 in the insulation layer 16.

The electrode 12 and the electrode 14 are respectively connected to a power supply (not shown), for instance, through a power supply circuit. Hence, a predetermined voltage for PM collection (hereinafter may be referred to as the collection voltage) can be applied between the electrode 12 and the electrode 14. The heater is connected to a power supply (not shown), for instance, through a power supply circuit. The element portion is heated when predetermined electrical power is supplied to the heater. The above-mentioned power supply circuits and other relevant circuits are connected to the control device 10 and controlled.

### [Overview of Control According to Present Embodiment]

In the present embodiment, the control device 10 exercises various control functions in accordance with the output of the PM sensor 8. The control functions of the control device 10 provide the detection of a PM emission amount, the restoration of the DPF 6, the fault judgment of the DPF 6, and the reset of the PM sensor 8.

### (1) Detection of PM Emission Amount

To detect the PM emission amount, the control device 10 applies the collection voltage across the electrodes 12, 14. If the collection voltage is applied across the electrodes 12, 14, then the PM in the exhaust gas deposits between the electrodes 12, 14. If the amount of PM deposited between the electrodes 12, 14 increases, then the number of electrically conductive paths between the electrodes 12, 14 increases to decrease the resistance between the electrodes 12, 14. Thus, the output value (current value) of the PM sensor 8 increases with an increase in the amount of PM deposited between the electrodes 12, 14. The control device 10 determines the amount of PM in the exhaust gas, that is, the PM emission amount, which is the amount of PM emitted downstream of the DPF 6, by detecting the output value (current value) of the PM sensor 8 that prevails when the collection voltage is applied. A state in which the collection voltage is applied to detect the PM emission amount may be hereinafter referred to as the PM detection mode. In the PM detection mode, it is assumed that the element portion is maintained at a temperature lower than 300° C.

### (2) Restoration of DPF 6

When the DPF 6 continues to collect the PM in the exhaust gas, the amount of PM deposited in the DPF 6 reaches its limit before long so that the DPF 6 can no longer collect the PM. To avoid such a situation, the PM is burned and eliminated to perform a process of restoring the DPF 6 when a certain amount of PM is deposited in the DPF 6.

More specifically, in the process of restoring the DPF 6, the control device 10 raises an exhaust temperature in accordance with a predetermined control program by exercising control, for instance, to perform an additional fuel injection after a fuel injection and retard fuel injection timing. The PM deposited in the DPF 6 is then burned and eliminated. As the deposited PM is burned and eliminated in this manner for a predetermined period of time, most of the PM deposited in the DPF 6 is eliminated to complete the restoration of the DPF 6.

The control device 10 estimates the amount of PM deposited in the DPF 6 by using a model or the like to estimate the amount of PM in the exhaust gas discharged from the internal combustion engine 2. When the estimated amount (hereinafter may be referred to as the estimated PM deposit amount) reaches a predetermined judgment amount, the control device 10 determines that the DPF 6 should be restored, and performs the above-described restoration process.

### (3) Fault Judgment of DPF

If the DPF 6 is faulty, the PM could be emitted into the atmosphere through the DPF 6. Therefore, the control device 10 exercises control to periodically judge whether the DPF 6 is faulty. More specifically, the control device 10 uses a model to estimate the amount of PM contained in the exhaust gas behind the DPF 6 (the exhaust gas downstream of the DPF 6). The control device 10 compares the estimated amount (hereinafter may be referred to as the estimated PM emission amount) against a PM emission amount based on the output of the PM sensor 8 to judge whether the DPF 6 is faulty. In other words, if the PM emission amount detected on the basis of the output of the PM sensor 8 is larger than the estimated PM emission amount, the control device 10 determines that the DPF 6 is faulty. The estimated PM emission amount is obtained by adding a permissible allowance to the estimated amount of emitted PM contained in the exhaust gas behind the DPF 6, which is calculated from the model.

### (4) PM Reset

In the above-described fault judgment of the DPF 6, the sensor output of the PM sensor 8 is used. The sensor output varies with the amount of PM deposited on the element portion. Therefore, when judging whether the DPF 6 is faulty, it is necessary to perform a process of eliminating the PM that has been deposited on the PM sensor 8. This process of eliminating the PM may be referred to as the PM reset.

When performing the PM reset, the control device 10 raises the temperature of the element portion of the PM sensor 8 by supplying predetermined electrical power to the heater for the PM sensor 8. The PM deposited on the element portion of the PM sensor 8 is then burned and eliminated. It is assumed that the PM reset is performed at a temperature higher than 500° C.

The PM reset can be variously timed. In general, the PM reset is performed immediately after the start of the internal combustion engine 2. After completion of the PM reset, the PM detection mode is used to judge whether the DPF 6 is faulty.

At the start of the internal combustion engine 2, however, condensed water may stay in the exhaust path 4. If the temperature of the PM sensor 8 is drastically raised while the PM sensor 8 is covered with the condensed water, the element portion of the PM sensor 8 may break. Therefore, when performing the PM reset after the start of the internal combustion engine 2, it is necessary to wait until the condensed water is discharged. Hence, when performing the PM reset at the start of the internal combustion engine 2, it is necessary to wait for a certain period of time before the PM sensor 8 begins to detect the amount of PM.

In the present embodiment, therefore, control is exercised immediately after the start of the internal combustion engine 2 so as to deposit no PM on the PM sensor 8 and enter the PM detection mode. More specifically, the fault judgment of the DPF 6 is implemented only once during a single operation between the start of the internal combustion engine 2 and the beginning of control. Then, during a single operation of the internal combustion engine 2, the PM reset is performed immediately after completion of the fault judgment of the DPF 6. After completion of the PM reset, the element temperature of the PM sensor 8 is maintained at the same high temperature as during the PM reset (at a temperature higher than 500° C.) until the internal combustion engine 2 stops. As the element temperature is maintained high as described above, the subsequent deposition of PM on the element portion is suppressed.

Consequently, when the internal combustion engine 2 starts again after it is stopped as mentioned above, no PM is deposited on the PM sensor 8. Therefore, when the internal combustion engine 2 starts again, it is possible to immediately detect the output of the PM sensor 8 and enter the PM detection mode without performing the PM reset. The PM detection mode is executed at a temperature lower than 300° C., that is, at a temperature lower than the temperature prevailing during the PM reset. Element breakage of the PM sensor 8 occurs when the temperature of the element portion is drastically raised while it is covered with water. However, such element breakage is unlikely to occur at a temperature of approximately 300° C., which prevails in the PM detection mode. Hence, as far as no PM is deposited on the PM sensor 8 at the start of the internal combustion engine 2, it is possible to immediately enter the PM detection mode without having to wait until the condensed water in the exhaust path is drained or dried out, and judge whether the DPF 6 is faulty.

### [Control Unique to Present Embodiment]

When the internal combustion engine 2 is cold started, the exhaust gas is likely to contain PM having a large particle diameter. When the PM has a large particle diameter, the conductivity between the electrodes 12, 14 is likely to be high no matter whether the actual amount of PM deposited on the PM sensor 8 is small. As a result, the PM sensor 8 is likely to generate a high output. Further, the element portion of the PM sensor 8 has a low temperature at the cold start of the internal combustion engine 2. Therefore, the electrical resistance between the electrodes 12, 14 is likely to be low.

Consequently, at a stage immediately after the cold start of the internal combustion engine 2, the output of the PM sensor 8 is particularly likely to vary. To immediately exercise control based on the output of the PM sensor 8 (for the purpose, for instance, of detecting the PM emission amount and determining the fault judgment of the DPF 6) without performing the PM reset at the start of the internal combustion engine 2 as described earlier, therefore, it is preferred that the influence of output variations of the PM sensor 8 be suppressed. In the present embodiment, therefore, the control device 10 not only exercises the earlier-described control, but also exercises control to correct the output of the PM sensor 8 in accordance with the temperature of cooling water (water temperature) at the start of the internal combustion engine

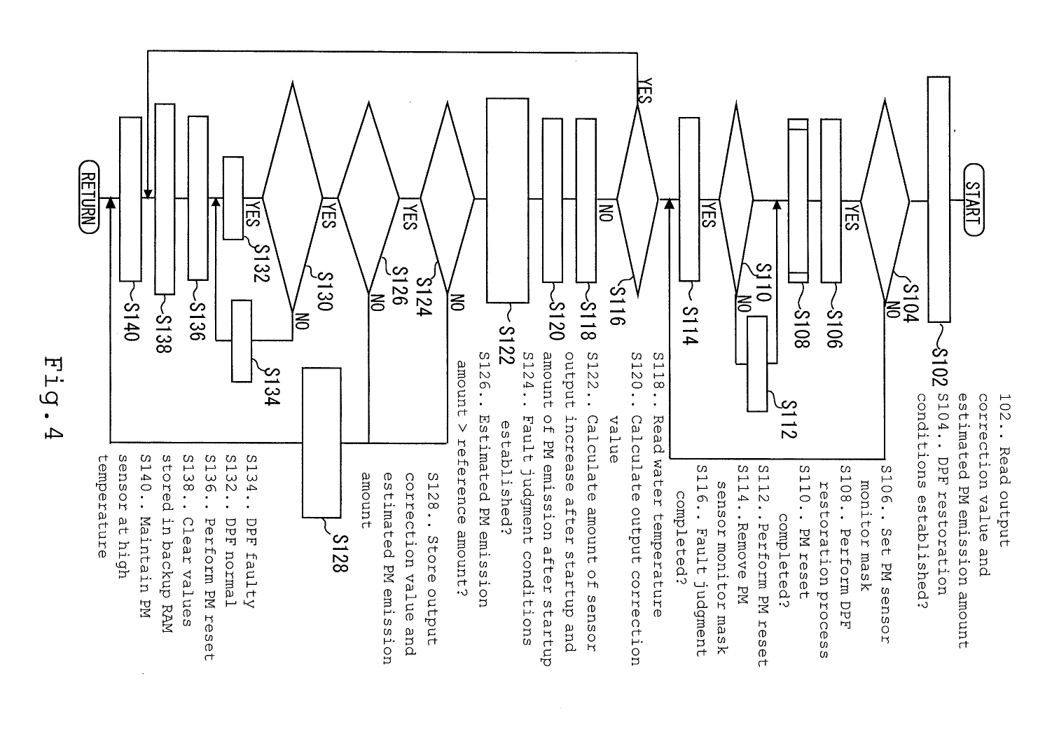

FIG. 3 is a diagram illustrating the relationship between the water temperature and the output sensitivity and output correction value of the PM sensor 8 according to the present embodiment. In FIG. 3, the horizontal axis indicates the water temperature, whereas the vertical axis indicates the output sensitivity and output correction value of the PM sensor 8. In FIG. 3, curve (a) represents the output sensitivity of the PM sensor 8 and curve (b) represents the output correction value of the PM sensor 8.

As shown in FIG. 3, there is a correlation between the water temperature and the output sensitivity of the PM sensor 8. Particularly, in a region where the water temperature is low, the output sensitivity tends to increase with a decrease in the water temperature. In the present embodiment, therefore, the output correction value is set so that the sensor output decreases with a decrease in the water temperature as indicated by curve (b). The relationship between the water temperature and the output correction value is predetermined by experiment or the like and stored in the control device 10 as a map.

The above process has been described on the assumption that the PM reset is performed after a fault detection sequence is followed for the DPF 6 during the last operation, and then the PM sensor 8 is maintained at a high temperature to stop the internal combustion engine 2. However, it is conceivable, for example, that the internal combustion engine 2 is stopped without completing the fault judgment of the DPF 6 and the PM reset during the last operation.

If, for example, the internal combustion engine 2 is stopped without completing the fault judgment of the DPF 6, the PM reset is not performed so that PM is deposited on the element portion of the PM sensor 8. In this instance, the control device 10 uses a backup RAM to store various information, such as a detection time at which the PM emission amount was detected during an operation, operating condition parameters for various output corrections, an output correction value calculated during the operation, a PM emission amount based on the output correction value, or an estimated PM emission amount, and an estimated amount of PM deposited on the DPF 6. When the internal combustion engine 2 is started later, the information stored in the backup RAM is used to resume the previously performed process without performing the PM reset.

In the above situation, it is conceivable that the water temperature at the current startup may differ from the water temperature at the last startup. Therefore, the PM emission amount is detected by detecting the difference between a value corrected in accordance with the current water temperature and the previous sensor output correction value, determining the amount of PM deposition equivalent to the difference, and adding the determined PM deposition amount to the last PM emission amount.

### [Details of Control Routine According to Present Embodiment]

FIG. 4 is a flowchart illustrating a control routine that is executed by the control device according to the present embodiment. The routine shown in FIG. 4 is repeatedly executed while the internal combustion engine 2 operates. When the internal combustion engine 2 starts, the routine shown in FIG. 4 first reads a PM sensor output correction value and a cumulative value of the estimated PM emission amount from the backup RAM (step S102). The output correction value and estimated PM emission amount are calculated and stored when the routine performs a later-described process.

Next, the routine judges whether restoration conditions for the DPF 6 are established (step S104). The restoration conditions for the DPF 6 are stored beforehand in the control device 10. The restoration conditions for the DPF 6 stipulate, for instance, that the temperature of the PM sensor 8 must be raised to its activation temperature, and that the estimated amount of PM deposited on the DPF 6 thus far must be larger than a judgment amount.

When, in step S104, the DPF restoration conditions are found to be established, the routine proceeds to step S106 and sets an output monitor mask on the PM sensor 8. More specifically, the collection voltage application to the PM sensor 8 is stopped so that the sensor output is left undetected. Next, the routine restores the DPF 6 (step S108). The restoration process for the DPF 6 is performed in accordance with a program that is separately stored in the control device 10. More specifically, control is exercised, for instance, to retard the fuel injection timing for the purpose of raising the exhaust temperature and burning and eliminating the PM deposited on the DPF 6.

Next, the routine judges whether the PM reset is completed (step S110). More specifically, the routine checks whether PM reset completion conditions are established, that is, checks whether, for example, the PM sensor 8 is maintained at a high temperature after the PM reset is performed during the last routine process, which will be described later.

If the completion of PM reset is not verified in step S110, the routine proceeds to step S112 and performs the PM reset. In step S112, necessary electrical power is supplied to the heater disposed to the element portion of the PM sensor 8. The element portion is then heated at a temperature higher than 500° C. to burn and eliminate the deposited PM.

When the PM reset is performed in step S112, the routine returns to step S110 and judges whether the PM reset is completed. More specifically, the routine checks whether PM completion conditions stored in the control device are established, that is, checks whether, for example, an adequate amount of time has elapsed since the beginning of PM reset in step S110 to burn and eliminate the PM deposited on the element portion.

When the completion of PM reset is verified in step S110 as a result of the above-described process, the routine proceeds to step S114 and removes the output monitor mask from the PM sensor 8. More specifically, the collection voltage is applied to the PM sensor 8 so that the output of the PM sensor 8 can be detected.

When steps S106 to S114 are completed to perform a process that includes the restoration of the DPF 6 and the PM reset, or when the restoration conditions for the DPF 6 are not found in step S104 to be established, the routine proceeds to step S116 and judges whether the fault judgment of the DPF 6 is completed during a current operation. The fault judgment of the DPF 6 is completed by performing a later-described process. When the fault judgment is executed once during each operation of the internal combustion engine 2, the control device 10 records the completion of the fault judgment. The judgment in step S116 is implemented by checking whether the completion of the fault judgment is recorded.

If the completion of the fault judgment is not verified in step S116, the routine proceeds to step S118 and detects the current water temperature. The water temperature is detected in accordance with the output of a water temperature sensor (not shown) that detects the cooling water temperature of the internal combustion engine 2.

Next, the routine calculates the PM sensor output correction value for a cold start (step S120). In step S120, a correction factor K is first calculated in accordance with the current water temperature by using the map stored beforehand in the control device 10. The output correction value is calculated by multiplying the current sensor output by the calculated correction factor K. If, for example, the PM sensor 8 is already warmed up due to the process performed in steps S106 to S114, the correction factor K is either 1 or a value close to 1 so that the output correction value is substantially the same as the sensor output. On the other hand, if, for example, the water temperature is low during the first process after startup, the correction factor K is considerably smaller than 1 so that the output correction value is smaller than the sensor output.

Next, a sensor output increase amount for the current routine and the PM emission amount based on the sensor output increase amount are calculated (step S122). More specifically, the difference between the output correction value calculated in step S120 of the current process and the output correction value read from the backup RAM during the last process (the current output correction value minus the last output correction value) is first determined as the output increase amount. The current PM emission amount is then calculated in accordance with the output increase amount. The calculated current PM emission amount is added to the last cumulative PM emission amount read in step S102 to obtain the current cumulative PM emission amount.

Next, the routine judges whether fault judgment conditions for the DPF 6 are established (step S124). The fault judgment conditions are stored beforehand in the control device 10 to represent, for instance, operating conditions under which the fault judgment can be properly executed. If the fault judgment conditions for the DPF 6 are found in step S124 to be established, the routine proceeds to step S128 and judges whether the estimated PM emission amount behind (downstream of) the DPF 6 has reached a reference amount.

If, on the other hand, the fault judgment conditions for the DPF 6 are not found in step S124 to be established, nor if the estimated PM emission amount is not found in step S126 to be larger than the reference amount, the routine proceeds to step S128 and stores the output correction value and PM emission amount calculated in step S122 in the backup RAM. Upon completion of step S128, the current process is terminated.

On the other hand, if the estimated PM emission amount is found in step S126 to be larger than the reference amount, the routine judges whether the next calculated PM emission amount is smaller than the estimated PM emission amount (step S130). More specifically, step S130 is performed to judge whether the PM emission amount downstream of the DPF 6, which was calculated in step S122, is smaller than the estimated PM emission amount downstream of the DPF 6 (including a predetermined allowance within a permissible range of emission), which is calculated on the basis of the model.

If, in step S130, the PM emission amount is found to be smaller than the estimated PM emission amount, an actual detected value (PM emission amount) is found to be smaller than the amount of PM emitted downstream of the DPF 6 including the permissible range of emission. Thus, it is determined that the PM is collected by the DPF 6, and that the DPF 6 is normal (step S132). If, on the other hand, the PM emission amount is not found to be smaller than the estimated PM emission amount, it means that the PM emission amount detected downstream of the DPF 6 is too great beyond the permissible range. In this instance, the routine determines that the DPF 6 is faulty (step S134), and performs a predetermined process, such as illuminating a warning lamp.

After completion of step S132 or S134 in which the DPF 6 is found to be either normal or faulty, the routine performs the PM reset (step S136). In step S136, predetermined electrical power is supplied to the heater disposed to the element portion of the PM sensor 8 to raise the temperature of the element portion. The PM deposited on the element portion is then burned and eliminated. Next, the routine performs step S138 so that the output correction value and PM emission amount stored in the backup RAM are cleared to zero.

After the values stored in the backup RAM are cleared to zero in step S138 or after the fault judgment of the DPF 6 is found in step S116 to be completed during the current operation, the routine proceeds to step S140, maintains the heater for the PM sensor 8 at a high temperature, and turns off the collection voltage. Upon completion of step S140, the current process is terminated. The resulting state is stored in the control device 10 so that the fault judgment of the DPF 6 and the PM reset are considered to be completed during the current operation as far as the routine is repeatedly executed.

Further, after the PM sensor 8 is maintained at a high temperature in step S140, the PM sensor 8 remains in a state where no PM is deposited on it. This state of the PM sensor 8 persists until the current operation comes to a stop. Therefore, no PM is deposited on the PM sensor 8 at the next start of the internal combustion engine 2. Consequently, the PM sensor 8 can be immediately set in the PM detection mode without performing the PM reset after the start of the internal combustion engine 2.

In the present embodiment, the output of the PM sensor 8 is corrected by using the correction value based on the water temperature as described above. Therefore, even in a state where the sensor output is likely to be high at a cold start, control can be exercised with high accuracy, for instance, to judge whether the DPF 6 is faulty.

The present embodiment has been described on the assumption that the current PM emission amount is determined by calculating the output correction value each time the routine is executed, determining the current PM emission amount in accordance with the difference between the calculated output correction value and the last output correction value, and adding the current PM emission amount to the last cumulative PM emission amount. However, the present invention is not limited to the above method. For example, an alternative may be to store only the water temperature at the start of the internal combustion engine as startup information and determine the output correction value in accordance with the startup information only.

Further, the output correction value need not always be calculated each time the execution of the routine is repeated. For example, an output correction may alternatively be made once or several times in accordance with prevailing operating information during a predetermined period between startup and warm-up. This alternative also makes it possible to deal with a situation where the output variations are particularly likely to occur at startup and effectively correct the output variations.

The present embodiment has also been described on the assumption that the output correction value is constantly calculated while the execution of the routine is repeated after the start of the internal combustion engine. However, the present invention is not limited to such a method. For example, an alternative may be to perform a sensor output correction process during only a period between the start of the internal combustion engine and the completion of particulate matter sensor warm-up or during only a period between the cold start of the internal combustion engine 2 and warm-up. Another alternative may be, for example, to repeatedly correct the sensor output in accordance with operating status during a period predetermined as mentioned above, correct the sensor output the first several times only during such a period, or correct the sensor output during a shorter period only or a predetermined number of times only. This method of correcting the sensor output during a limited period of startup (or cold startup) makes it possible to narrow a region where the sensor output is likely to vary and effectively suppress sensor output variations.

The present embodiment has also been described on the assumption that the sensor output is corrected in accordance with the temperature of the cooling water for the internal combustion engine 2. However, the present invention is not limited to such a method. For example, the sensor output need not always be corrected in accordance with the temperature of the cooling water, but may alternatively be corrected in accordance with the temperature of a portion correlated with the temperature of the internal combustion engine 2 or the temperature of the PM sensor 8. Further, the sensor output need not always be corrected in accordance with temperature. For example, the sensor output may be corrected in accordance with a cumulative intake air amount or a cumulative fuel injection amount. Sensor output sensitivity correlates with water temperature as the cumulative values of the cumulative intake air amount and cumulative fuel injection amount correlate with water temperature. Therefore, when the relationship between the sensor output sensitivity and the cumulative intake air amount or cumulative fuel injection amount is predetermined by experiment or the like and stored as a map or the like, as is the case with the water temperature, the sensor output can be corrected by using the intake air amount or fuel injection amount as a parameter.

The present embodiment has also been described on the assumption that the fault judgment of the DPF 6 and the following PM reset are performed only once during a single operation. However, the present invention is not limited to such a method. The fault judgment of the DPF 6 and the PM reset may be performed at a different timing. For example, the fault judgment of the DPF 6 and the PM reset may alternatively be performed several times during a single operation. Further, if, for instance, the output of the PM sensor 8 is required at startup, another alternative is to use a corrected sensor output at startup, as is the case with the present embodiment, and perform the PM reset after the PM sensor 8 is warmed up.

The present embodiment has also been described on the assumption that the DPF 6 is restored when predetermined conditions are met, that is, when, for instance, an estimated PM deposition amount exceeds a judgment amount. However, the present invention is not limited to the above restoration timing of the DPF 6. The DPF 6 may alternatively be restored under different conditions. For example, the DPF 6 may be restored once each time a predetermined distance is traveled by a vehicle.

In the present embodiment, the PM sensor 8 that was maintained clear of deposited PM due to a temperature rise during the last operation of the internal combustion engine is particularly effective when the internal combustion engine 2 is to be cold started. However, the present invention is not limited to such a situation. In the present invention, the correction made in accordance with the water temperature can be effectively applied to a situation where the use of the PM sensor 8 is desired immediately after startup.

The present embodiment has also been described on the assumption that the deposition of PM is avoided by maintaining the element portion at a high temperature after the PM reset. However, the present invention is not limited to such a method. For example, the application of the collection voltage may alternatively be stopped to maintain a state where the PM does not deposit.

The present embodiment has also been described on the assumption that the output of the PM sensor 8 is detected by detecting an electrical current. However, the present invention is not limited to such a method. The output of the PM sensor may alternatively be detected by detecting another electrical property.

When the number, quantity, amount, range, or other numerical attribute of an element is mentioned in the above description of the embodiment, the present invention is not limited to the mentioned numerical attribute unless it is unequivocally stated or theoretically defined. Further, structures and steps of methods described in connection with the embodiment are not necessarily essential to the present invention unless they are unequivocally stated or theoretically defined.

### DESCRIPTION OF NOTATIONS

2 internal combustion engine

4 exhaust path

6 DPF (diesel particulate filter)

8 PM sensor

10 control device

1. A control device for controlling an internal combustion engine having a particulate matter sensor that is installed in an exhaust path of the internal combustion engine to generate an output in accordance with the amount of particulate matter in a gas, the control device comprising:
means for detecting the output of the particulate matter sensor;
means for detecting information about the operating status of the internal combustion engine; and
means for correcting the output in accordance with the information during a predetermined period from the startup and warm-up of the internal combustion engine.

2. The control device according to claim 1, further comprising:
means for eliminating the particulate matter deposited on an element portion of the particulate matter sensor by heating the element portion to a reference temperature after the internal combustion engine is warmed up.

3. The control device according to claim 1, wherein the means for detecting the information about the operating status continues to detect the information about the operating status during a period from the start of the internal combustion engine to the instant at which the particulate matter sensor is warmed up, and
wherein the means for correcting the output continues to correct the output during a period from the start of the internal combustion engine to the instant at which the particulate matter sensor is warmed up.

4. The control device according to claim 1, wherein, when the internal combustion engine cold starts, the means for detecting the information about the operating status continues to detect the information about the operating status during a period from the cold start of the internal combustion engine to the instant at which the internal combustion engine is warmed up, and
wherein the means for correcting the output continues to correct the output during a period from the cold start of the internal combustion engine to the instant at which the internal combustion engine is warmed up.

5. The control device according to claim 1, wherein at least one of the temperature of cooling water for the internal combustion engine, a cumulative intake air amount reached since the start of the internal combustion engine, and a cumulative fuel injection amount reached since the start of the internal combustion engine is detected as the information about the operating status.

6. The control device according to claim 1, further comprising:
means for judging, in accordance with the output corrected by the means for correcting the output, whether a filter for collecting the particulate matter is faulty;
means for eliminating the particulate matter deposited on the element portion of the particulate matter sensor by heating the element portion to the reference temperature after judging whether the filter is faulty; and
means for maintaining the element portion of the particulate matter sensor at a temperature higher than the reference temperature during a period from the instant at which the particulate matter is eliminated to the instant at which the internal combustion engine is stopped.

7. A control device for controlling an internal combustion engine having a particulate matter sensor that is installed in an exhaust path of the internal combustion engine to generate an output in accordance with the amount of particulate matter in a gas, the control device programmed to:
detect the output of the particulate matter sensor;
detect information about the operating status of the internal combustion engine; and
correct the output in accordance with the information during a predetermined period from the startup and warm-up of the internal combustion engine.

8. The control device according to claim 2, wherein the means for detecting the information about the operating status continues to detect the information about the operating status during a period from the start of the internal combustion engine to the instant at which the particulate matter sensor is warmed up, and
wherein the means for correcting the output continues to correct the output during a period from the start of the internal combustion engine to the instant at which the particulate matter sensor is warmed up.

9. The control device according to claim 2, wherein, when the internal combustion engine cold starts, the means for detecting the information about the operating status continues to detect the information about the operating status during a period from the cold start of the internal combustion engine to the instant at which the internal combustion engine is warmed up, and
wherein the means for correcting the output continues to correct the output during a period from the cold start of the internal combustion engine to the instant at which the internal combustion engine is warmed up.

10. The control device according to claim 2, wherein at least one of the temperature of cooling water for the internal combustion engine, a cumulative intake air amount reached since the start of the internal combustion engine, and a cumulative fuel injection amount reached since the start of the internal combustion engine is detected as the information about the operating status.

11. The control device according to claim 2, further comprising:
means for judging, in accordance with the output corrected by the means for correcting the output, whether a filter for collecting the particulate matter is faulty;
means for eliminating the particulate matter deposited on the element portion of the particulate matter sensor by heating the element portion to the reference temperature after judging whether the filter is faulty; and
means for maintaining the element portion of the particulate matter sensor at a temperature higher than the reference temperature during a period from the instant at which the particulate matter is eliminated to the instant at which the internal combustion engine is stopped.

12. The control device according to claim 3, wherein at least one of the temperature of cooling water for the internal combustion engine, a cumulative intake air amount reached since the start of the internal combustion engine, and a cumulative fuel injection amount reached since the start of the internal combustion engine is detected as the information about the operating status.

13. The control device according to claim 3, further comprising:
means for judging, in accordance with the output corrected by the means for correcting the output, whether a filter for collecting the particulate matter is faulty;
means for eliminating the particulate matter deposited on the element portion of the particulate matter sensor by heating the element portion to the reference temperature after judging whether the filter is faulty; and
means for maintaining the element portion of the particulate matter sensor at a temperature higher than the reference temperature during a period from the instant at which the particulate matter is eliminated to the instant at which the internal combustion engine is stopped.

14. The control device according to claim 4, wherein at least one of the temperature of cooling water for the internal combustion engine, a cumulative intake air amount reached since the start of the internal combustion engine, and a cumulative fuel injection amount reached since the start of the internal combustion engine is detected as the information about the operating status.

15. The control device according to claim 4, further comprising:
means for judging, in accordance with the output corrected by the means for correcting the output, whether a filter for collecting the particulate matter is faulty;
means for eliminating the particulate matter deposited on the element portion of the particulate matter sensor by heating the element portion to the reference temperature after judging whether the filter is faulty; and
means for maintaining the element portion of the particulate matter sensor at a temperature higher than the reference temperature during a period from the instant at which the particulate matter is eliminated to the instant at which the internal combustion engine is stopped.
